(19) United States
(12) Patent Application Publication
(10) Pub. No.: US 2025/0124365 A1
(43) Pub. Date: Apr. 17, 2025

(54) HYBRID CLASSIC-QUANTUM SYSTEM FOR LARGE CAPACITATED VEHICLE ROUTING PROBLEM (CVRP)

(71) Applicant: Unisys Corporation, Blue Bell, PA (US)

(72) Inventors: Salvatore SINNO, Durham (GB); Alan MOTT, Northamptonshire (GB); Arati SAHOO, Bengaluru (IN); Shruthi THURAVAKKATH, Bangalore (IN); Antonio Dauphin FERNANDO D, Chennai (IN)

(21) Appl. No.: 18/582,948

(22) Filed: Feb. 21, 2024

(30) Foreign Application Priority Data
Oct. 16, 2023 (IN) 202311070271

(51) Int. Cl. G06Q 10/047; G06N 10/60

(52) U.S. Cl. CPC G06Q 10/047

(57) ABSTRACT

Hybrid classical-quantum systems for improved vehicle routing use a combination of genetic algorithms, simulated annealing, and quantum annealing. The hybrid method allows further exploration of the solution space of a capacitated vehicle routing problem (CVRP), thus identifying improved routing results. Nodes (i.e., locations) are initially clustered, and the node clusters are processed via a genetic algorithm to determine potential solutions. The potential solutions are evolved using simulated annealing to generate evolved solutions, each having evolved node clusters. An evolved solution is selected. Each of the evolved node clusters for the selected evolved solution is separately annealed by a quantum annealer to determine the optimal route through the evolved node clusters.

### CROSS-REFERENCE TO RELATED APPLICATIONS

This application claims the benefit of priority to Indian Patent Application number 202311070271, filed in the Indian Patent Office on Oct. 16, 2023, and entitled “Hybrid Classic-Quantum System for Large Capacitated Vehicle Routing Problem (CVRP),” the contents of which are hereby incorporated by reference in their entirety.

### BACKGROUND

The Capacitated Vehicle Routing Problem (CVRP) is a classic optimization problem in operations research and logistics. In CVRP, a fleet of vehicles serves a set of customers located at various delivery points. Each customer has a specific demand for goods or services that must be satisfied, and each vehicle has a limited capacity to carry these goods.

The objective of the CVRP is to determine the most efficient routes for vehicles to deliver goods to all customers while respecting vehicle capacity constraints. The goal is to minimize the total distance travelled, the number of vehicles used, or both, depending on the specific variant of the problem.

The CVRP finds practical applications in various real-world scenarios, such as package delivery, waste collection, and public transportation, where optimizing vehicle routes can lead to cost savings, reduced transportation time, and improved overall efficiency.

### SUMMARY

The technology generally relates to vehicle routing using quantum computing. In a particular aspect, a hybrid classical-quantum metaheuristic for solving the large Capacitated Vehicle Routing Problem (CVRP) and routing vehicles via an optimal route is provided.

The technology defines a new hybrid approach that addresses large CVRP. The method generates high-quality solutions, even when dealing with exceedingly large instances, such as those involving 20,000 instances or more, while maintaining reasonable computing times. The technology leverages quantum annealing, simulated annealing, and genetic algorithm methodologies.

In an example, nodes that represent locations are clustered. The nodes are clustered such that each node is assigned to only one node cluster. Potential solutions from the node clusters can be determined using a genetic algorithm. Thus, the potential solutions include refined node clusters that connect the nodes in a route.

The potential solutions are then evolved further through a simulated annealing process to output evolved solutions having evolved node clusters. The evolved node clusters each include nodes, and each node is assigned to one evolved node cluster. The nodes of the evolved node clusters are also connected via a route. In this way, the system seeks to improve the routes determined through the nodes.

A quantum annealer can then be employed to anneal one of the evolved solutions, which can be selected based on a minimum total route distance between the corresponding evolved node clusters. Using the quantum annealer, an optimal route through each of the nodes of the evolved node clusters is determined. For instance, the optimal route may include an order of nodes in each evolved node cluster that minimizes the overall distance or other variable of the route between the nodes. Each cluster can be assigned to a vehicle that traverses the routes.

In instances where there are more evolved node clusters having optimal routes than vehicles, some of the evolved node clusters can be combined to join their respective optimal routes so that the number of evolved node clusters having optimal routes is equal to the number of vehicles available to traverse the routes. For instance, a cluster centroid can be determined for each cluster, and those evolved node clusters having the closest cluster centroids may be identified and combined.

This summary is intended to introduce a selection of concepts in a simplified form that is further described in the Detailed Description section of this disclosure. The Summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 illustrates an example operating environment in which aspects of the technology may be employed, in accordance with an aspect described herein;

FIG. 2 illustrates a flow diagram of an example method performed using the technology, in accordance with an aspect described herein;

FIGS. 3A-B illustrate an example determination of optimal routes from a set of nodes, in accordance with an aspect described herein;

FIG. 4 illustrates an example route combination for a set of optimal routes, in accordance with an aspect described herein;

FIG. 5 illustrates an example method for generating an optimal routing solution, in accordance with an aspect described herein;

FIG. 6 illustrates an example quantum annealer suitable for use with the present technology, in accordance with an aspect described herein;

FIG. 7 illustrates an example quantum annealing process that may be performed by the quantum annealer of FIG. 6 to determine an optimal routing solution, in accordance with an aspect described herein; and

FIG. 8 illustrates an example computing device suitable for implementing aspects of the present technology, in accordance with an aspect described herein.

### DETAILED DESCRIPTION

The capacitated vehicle routing problem (CVRP) is an NP (nonpolynomial)-complete combinatorial optimization problem in operations research and logistics. It involves determining the most efficient routes for vehicles to deliver goods to a set of nodes (locations) while respecting vehicle capacity constraints. In many cases, the objectives are to minimize the distance travelled, optimize resource utilization, and reduce transportation costs.

The computational complexity of an NP problem is the amount of time it would take for a computer to solve the problem if the computer had unlimited resources. NP-complete problems are believed to be not solvable in polynomial time by any deterministic Turing machine.

Heuristic and metaheuristic methods for solving CVRP have shown reasonable success for small to medium-sized instances. However, as the problem grows, classical algorithms' computation time and memory requirements increase exponentially, making them impractical for large-scale CVRP instances commonly encountered in real-world scenarios.

The emergence of quantum computing has opened new avenues for tackling complex optimization problems like the CVRP. Quantum computing leverages the principles of quantum mechanics to perform computations on quantum bits (qubits), allowing for parallelism and exploiting quantum phenomena such as superposition and entanglement to explore potential solutions more efficiently.

Solutions to the problem are limited or undiscoverable with many existing conventional computational methods. This is in part due to vast search spaces (e.g., an extremely large solution domain with many possible candidate solutions), significant solution times due to computational limitations, and discovery of relatively low-quality solutions of all of the possible solutions in the solution space.

As an example, for the candidate solution given n nodes (i.e., locations) and k vehicles, there is an extremely large search space. The number of possible ways to allocate these nodes among the k vehicles is given by the formula:

$$( k + n - 1 ) ! / ( n ! * ( k - 1 ) ! .$$

This number becomes astronomical very quickly, and rapidly hits a threshold that no current classical computing device can solve. Even adopting the classical metaheuristic, the solving time grows exponentially with the number of nodes and vehicles.

Some conventional approaches use exact algorithms and aim to find the optimal solution by systematically exploring the entire solution space. They guarantee to find the best solution, but their computational complexity often limits their application to small or moderately sized instances, and cannot be scaled with the size of the solution space, which as noted, is an exponential growth, effectively limiting these methods to only minor applications.

Other conventional methods use heuristic algorithms. Such conventional algorithms are designed to find good-quality solutions quickly but do not guarantee optimality. They use efficient strategies to explore the solution space, which makes them suitable for larger instances. However, these methods can take significantly long computational times. Moreover, some attempted solutions use metaheuristics. Metaheuristics are higher-level procedures that guide the search process to navigate the solution space. They are relatively more flexible. However, one of the problems with this approach is that it is not guaranteed to reach an optimal solution.

To overcome some of these challenges and advance the space of routing vehicles, aspects of the technology use parallel computation in the classical section and quantum parallel execution. This combined approach results in a better explored solution space, meaning the identification of better solutions at a more efficient computational level relative to some conventional techniques. Aspects of the technology further provide a mechanism to assess the quality of the quantum solution and how close it is to an optimal solution, which provides further understanding of the solution space and helps determine when computational resources are no longer efficiently navigating the space, thus allowing the optimal solution to be selected while minimizing computational processing.

To achieve these benefits and identify optimal solutions to the CVRP, the technology provides a genetic algorithm that is used to identify potential solutions using techniques such as cross-over, mutation, and combination to evolve the potential solutions and obtain a set of evolved solutions. The novel implementation of the genetic algorithm on parallel devices (e.g., GPUs) helps ensure that this phase is quickly completed.

Simulated annealers use the potential solutions obtained from the genetic algorithm. Simulated annealing reduces the size of the solution space by proposing a family of evolved solution, where each evolved solution includes evolved node clusters having routes for a set of nodes. The simulated annealing metaheuristic creates groups of nodes of locations that can be traversed by a vehicle. Essentially, the simulated annealing breaks the CVRP problem in k TSP subproblems (where k is the number of evolved node clusters). This overcomes one of the main challenges of the simulated annealing metaheuristic, which is the slow convergence from the initial solution. The present technology helps solve this problem because the genetic algorithm provides the simulated annealing algorithm with a promising starting point to start a local search from a promising position.

The present technology further combines state-of-the-art metaheuristics with quantum computing (quantum annealing) to solve very large CVRP combinatorial problems for a vast number of nodes, even those problems with more than 20,000 nodes. To do so, the technology provides a hybrid combination of quantum algorithms and classical metaheuristic methodologies working together to solve these large instances.

For instance, the evolved node clusters of the evolved solution from the simulated annealing can be provided to the quantum annealer. Here, the quantum annealer anneals each evolved node cluster separately, thus identifying the optimal route between the nodes of each evolved node cluster. The solution space is more deeply explored relative to conventional methods because the quantum annealer is treating each evolved node cluster as an individual TSP problem, thus finding a route through the nodes that would otherwise likely not be identified using any one of the genetic algorithm, simulated annealing, or quantum annealing approaches on its own.

This hybrid quantum-classic approach provides successful alternatives to the classical approach and also overcomes the quantum-only approach's limitations (e.g., size and time to solve). It allows quantum and classical computers to be orchestrated to solve very large combinatorial problems for routing vehicles.

The technology adopts a hybrid classic and quantum algorithm integrating a genetic algorithm and simulated annealing metaheuristics with quantum annealing, providing the quantum annealer an advanced method that allows it to explore the solution space it otherwise would not explore using the conventional methodologies. One limit is the problem's size; the combination of genetic algorithm and simulated annealing reduces the problem to smaller problems that can be solved in parallel. Also, the technology coordinates the execution of the k TSP problems, aggregates them, and manages the interface with the end user.

An aspect uses a multistage approach: clustering and routing. The clustering problem may be solved for Kₘₐᵣ clusters using the genetic algorithm, and the simulated annealing further creates partitions for each of the Kₘₐᵣ clusters. Routing uses asynchronous annealing for the k TSP problems. The clustering algorithm adopts simulated annealing, and the initial solution is generated using the genetic algorithm. The hybrid approach of using a genetic algorithm and simulated annealing offers a novel strategy for tackling quadratic unconstrained binary optimization (QUBO) problems. By capitalizing on the strengths of both algorithms, this approach significantly reduces convergence time and increases solution quality. Then, by harnessing the unique properties of quantum mechanics, quantum annealing explores vast solution spaces much more efficiently than classical optimization methods.

It will be realized that the method previously described is only an example that can be practiced from the description that follows, and it is provided to more easily understand the technology and recognize its benefits. Additional examples are now described with reference to the figures.

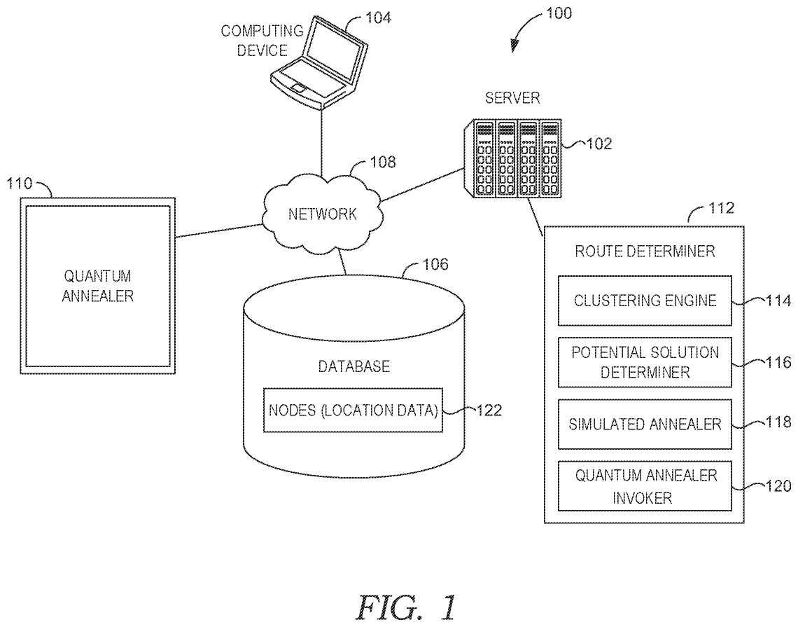

With reference now to FIG. 1, an example operating environment 100 in which aspects of the technology may be employed is provided. Among other components or engines not shown, operating environment 100 comprises server 102, computing device 104, database 106, and quantum annealer 110, which are communicating via network 108.

Database 106 generally stores information, including data, computer instructions (e.g., software program instructions, routines, or services), or models used in embodiments of the described technologies. Although depicted as a single database component, database 106 may be embodied as one or more databases or may be in the cloud. In aspects, database 106 is representative of a distributed ledger network.

Network 108 may include one or more networks (e.g., public network or virtual private network [VPN]), as shown with network 108. Network 108 may include, without limitation, one or more local area networks (LANs), wide area networks (WANs), or any other communication network or method.

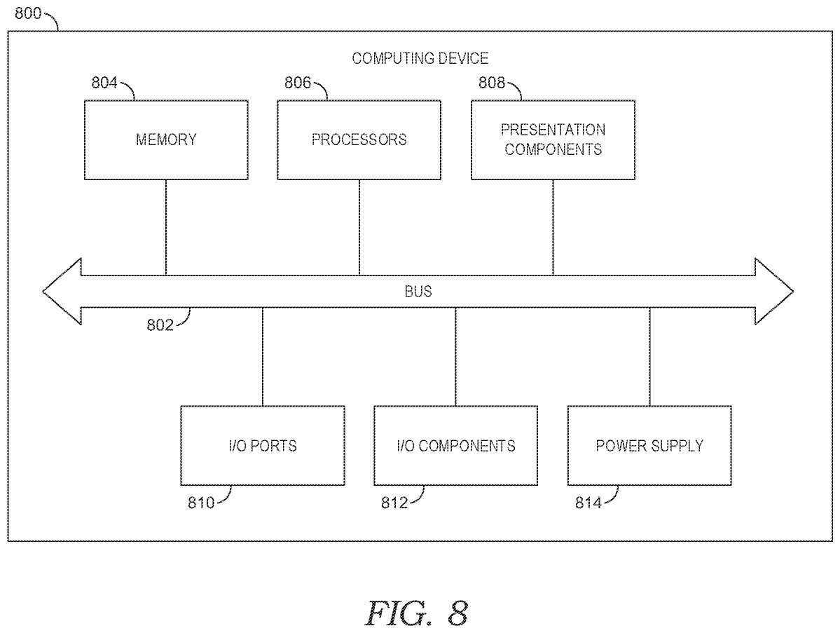

Generally, server 102 is a computing device that implements functional aspects of operating environment 100, such as one or more functions of route determiner 112 to determine routes for vehicles. One suitable example of a computing device that can be employed as server 102 is described as computing device 800 with respect to FIG. 8. In implementations, server 102 represents a back-end or server-side device.

Computing device 104 is generally a computing device that may be used to interface with server 102 for facilitating the determination of optimal routes for vehicles traversing through locations (also referred to as a node). In aspects, computing device 104 may provide information such as nodes (location data) 122, which can include the locations for which routes are determined, along with vehicle information, such as the number of vehicles available for routes, among other location and vehicle data.

As with other components of FIG. 1, computing device 104 is intended to represent one or more computing devices. One suitable example of a computing device that can be employed as computing device 104 is described as computing device 800 with respect to FIG. 8. In implementations, computing device 104 is a client-side or front-end device. While the example architecture illustrated in FIG. 1 illustrates functions of route determiner 112 being performed by server 102, it will be understood that this is just one example, and there may be more or fewer functions of route determiner 112, which may be employed in various orders. It is further noted that, in some implementations of the technology, functions of route determiner 112 may be performed by other components of FIG. 1, or by components not show. As an example, in some implementations, computing device 104 may be used to perform functions of route determiner 112 in lieu of or in combination with server 102. The illustrated drawing is but one example used to aid in describing an aspect of the technology.

Quantum annealer 110 may generally comprise an analog quantum computing device, such as those suitable for performing quantum annealing. As will be further described, quantum annealer 110 may receive instructions from other components of FIG. 1 for solving a quantum problem, such as an optimization problem. Quantum annealer 110 may be configured to determine or receive a quantum problem and find an optimal or near-optimal solution to the problem through an annealing process, such as quantum annealing process 700. Quantum annealer 600 represents an example quantum annealer 600 that may be suitable as quantum annealer 110.

Route determiner 112 generally determines the optimal route through locations, represented and referred to as “nodes.” In an example implementation, route determiner 112 clusters nodes through which a route may pass. For example, this could be to deliver cargo by a fleet of vehicles to various locations, to move objects around a warehouse, to transport people to various locations (e.g., an airline or bus fleet), or other like use cases. Once node clusters are determined, the node clusters are subjected to a genetic algorithm to determine potential solutions. The potential solutions comprise refined node clusters, i.e., groups of nodes along a theoretically better route. Simulated annealing is performed on the potential solutions to generate evolved solutions. Each evolved solution comprises evolved node clusters. The evolved node clusters comprise groups of nodes along, again, a theatrically better route relative to the potential solutions. Each of the evolved node clusters for at least one of the evolved solutions is separately annealed to determine the optimal route through the nodes. The optimal route may minimize the distance, or solve for another variable, between the nodes of the evolved node clusters. This is just one example, and other examples will be described and understood from this disclosure.

As used herein, a vehicle is a mobile unit designed to transport goods, people, or execute specific tasks across various terrains including land, sea, air, or within confined environments like warehouses and manufacturing facilities. Examples encompass trucks and forklifts on land for long-distance transportation and handling materials, cargo ships and barges at sea for large-scale and localized maritime transportation, and aircraft like cargo planes in the air. Within warehouses, manufacturing settings, sorting facilities, or the like, vehicles like conveyor belts, automated guided vehicles (AGVs), and mobile robots may move materials through production lines or storage areas, just to provide a few examples.

In an implantation, route determiner 112 can be employed to determine the optimal routes for vehicles given the defined set of nodes, objectives, and constraints. The objective function and the constraints may be provided to the quantum annealer so that the quantum annealer may explore the solution space in which distance between nodes is minimized, for example. As will also be further described, the technology may employ a classical computing device to reduce the solution space that the quantum annealer explores by applying a genetic algorithm and simulated annealing.

To determine optimal routes, the example route determiner 112 illustrated in FIG. 1 employs clustering engine 114, potential solution determiner 116, simulated annealer 118, and quantum annealer invoker 120. In a high-level example, these may be employed to cluster nodes input to a genetic algorithm that determines node clusters, e.g., groups of nodes through which a route may be determined. The node clusters are provided to a genetic algorithm to generate potential solutions having theoretically better routes through refined node clusters. The potential solutions are provided to a simulated annealing process that generates evolved solutions having evolved node clusters that have routes theoretically better than the potential solutions. This process may be an iterative process. At the end of the iterative process, the evolved solution having a minimum total route distance is annealed by a quantum annealer to identify an optimal route through the nodes of each evolved node cluster. In aspects, route determiners 112 may combine any number of optimal routes to match a number of vehicles available to service the routes.

To form node clusters, route determiner 112 may employ clustering engine 114. Clustering engine 114 may access nodes (location data) 122 that include location data for each node. That is, a node may represent a location relative to another node location. As such, each node could be defined in terms of distance from other nodes. In an aspect, a clustering constraint includes each node being assigned to only one node cluster. Another constraint may include vehicle capacity or capability. Any one or more constraints may be applied to cluster the nodes. In an aspect, the nodes are initially clustered by assigning nodes to cluster randomly or sequentially to generate node clusters. The clustering may be performed to generate an initial population of node clusters for which potential solutions can be determined using a genetic algorithm, as will be further described.

In one example, the number of node clusters in which to assign nodes is determined to match a number of vehicles that are available to traverse routes determined through the nodes of each node cluster. Thus, for example, if there were 100 available vehicles, then clustering engine 114 may generate 100 node clusters by assigning nodes to each node cluster.

In aspects, the number of node clusters in which to assign nodes is determined based on the total number of nodes and the constraint density threshold of quantum annealer 110. With regard to quantum annealer 110, the constraint density is generally a measure of how many constraints are present relative to the number of variables for a problem being solved by quantum annealer 110. It generally provides an idea of how complex or tightly bound the problem is. Quantum annealer 110 has a constraint density threshold, which is the maximum constraint density for a given problem that quantum annealer 110 can solve, as determined, at least in primary part, by the number of qubits and their interactions of the quantum annealer. As such, various quantum annealers have different constraint density thresholds, and the constraint density thresholds may increase over time due to technological advances and additional qubits corresponding to a quantum annealer. In the instant example, the constraint density of the problem to be solved is based on the number of nodes in a cluster for which a route is determined by the quantum annealer, the objective function, and the constraints applied when invoking quantum annealer 110. As an example, the constraint density threshold can be learned empirically by using or attempting to use quantum annealer 110 to solve for optimal routes of various node cluster sizes for a given objective function and constraints.

In an aspect, the number of node clusters is determined by maximizing the node cluster size below the constraint density threshold for the nodes assigned to each cluster. For instance, if the constraint density threshold is exceeded with a cluster of 76 nodes, then each cluster could be assigned 75 nodes. The number of node clusters, in this example, is determined based on the total number of nodes to be assigned to node clusters and the maximum number of nodes below the constraint density threshold. In general, this maximizes the efficiency of quantum annealer 110, since each cluster of nodes, after application of the genetic algorithm and the simulated annealing, will be solved independently. As such, fewer solutions are required by quantum annealer 110 to identify the optimal routes.

In some cases, the number of node clusters may exceed the number of available vehicles. As will be further described, clusters of nodes may later be combined to determine a number of optimal routes that matches the number of vehicles available to traverse the routes.

To provide an example, during clustering by clustering engine 114, each node may be assigned to one (and only one) node cluster. As an example, an iterative clustering algorithm may be used to sequentially solve a series of clustering problems until the number of node clusters is achieved. The goal of this example is to group together, i.e., cluster, nodes that may be served by the same vehicle, e.g., through which a route may be determined.

As an example, let k node clusters be determined using the following parameters:
Cᵢⱼ: Distance or cost to travel from node (location) i to node (location) j.
Dᵢ: Demand requirement for i.
Q: Individual capacity for each vehicle (or route).
K: Exact or minimum number of vehicles (or routes).
xᵢₖ: Binary, indicating whether node i is assigned to cluster (route) k.

Some example constraints that can be applied in this example may include: single node constrain, where each node is on one and only one route:

$${\sum }_{k = 1}^{K} {x}_{ik} = 1 , ∀ i ∈ \{ 1 , … , N \} ;$$

and
route capacity constraints:

### Non-Provisional Application

$${\sum }_{i = 1}^{N} {D}_{i} {x}_{ik} \leq Q , ∀ k ∈ \{ 1 , … , K \} .$$

The objective in this example can minimize the sum of the pairwise distances within each cluster, formulated as:

$$min {\sum }_{k = 1}^{K} {\sum }_{i , j} {C}_{ij} {x}_{ik} {x}_{jk} .$$

As provided, clustering engine 114 may assign nodes to node clusters by minimizing the distance between the nodes for each of the node clusters. Other factors may also be considered and are provided as examples. For instance, the demand requirement for i provides a location constraint. This could indicate a demand for a particular location as to people, cargo, or other items being delivered to the location, or other requirements of the location. For example, if a cement truck is traveling through multiple nodes to deliver cement, then the demand for the total number of nodes cannot be greater than the amount of material that can be carried by the cement truck. As such, location constraint may be used when assigning nodes to node clusters during node cluster generation. Another example constraint that might be included is a vehicle constraint, as designed by Q, which here represents the individual capacity for each vehicle. For example, a node cluster may be limited to those nodes for which a vehicle can traverse based on its carrying capacity. That is, in this case, a cluster may be restricted from including locations at which more deliveries are needed that a vehicle traversing along the nodes may carry. These are just some example location constraints and vehicle constraints that may be used to cluster nodes to generate node clusters, and may be used in addition to or in lieu of other constraints.

Once clustered, a genetic algorithm can be employed using potential solution determiner 116 to determine potential solutions. In an aspect, the node clusters are determined using genetic algorithms in parallel, which provides a quick initial set of potential routes. For instance, a computing device, such as a high-performance computing device, may employ parallel processing techniques, such as using multiple GPUs, to determine the potential solutions in parallel.

In general, a genetic algorithm can include an adaptive heuristic search method and can identify potential solutions by evolving a population of candidate solutions towards an optimum. The genetic algorithm may begin with a population of candidate solutions; in this case, the node clusters generated using clustering engine 114. This population undergoes iterative transformations through operations such as selection, crossover (recombination), and mutation, driven by a fitness function that evaluates how close a given solution is to the desired outcome. The resulting potential solutions provide refined node clusters that include nodes for which routes are determined that are theoretically better than the input node cluster routes.

As will be further discussed, the genetic algorithm may be used as part of an iterative process with the simulated annealing. As such, the initial population for the genetic algorithm may come from node clusters generated by clustering engine 114, while subsequent populations on which the genetic algorithm is employed may be further evolved solutions as determined by a simulated annealing process further described below. Thus, the node clusters from which the potential solutions are defined using the genetic algorithm may comprise prior evolved node clusters determined by the simulated annealing during a prior iteration.

One of the goals when applying the genetic algorithm can be to find the shortest possible route for each set of nodes in a node cluster, thereby generating a refined node cluster. In employing the genetic algorithm, each candidate solution represents a possible route. A fitness function, e.g, the inverse of the total distance traveled, can be selected for generating the potential solutions. In each iteration or generation, routes are selected to be parents based on their fitness, with shorter routes being more likely to be selected. Through crossover, pairs of parent routes are combined to create new routes, and through mutation, some parts of these routes are randomly altered to introduce variability. Over successive epochs, the population evolves, with shorter routes becoming more common, and thus generating the potential solutions having the refined node clusters.

For example, potential solution determiner 116 employs a genetic algorithm on an initial population of clusters (e.g, ten or more solutions are solved where nodes are allocated to one of the routes). The genetic algorithm is used to quickly find potential solutions. As an example, the genetic algorithm may be applied for 100 epochs, although other suitable thresholds can be used.

One example genetic algorithm selects from an initial population of clusters, e.g., those generated from the clustering or from the output evolved node clusters. Once selected, crossover (also referred to as recombination), mutation, evaluation, and replacement techniques can be employed to form the next generation, which may continue through any determined time or through any number of epochs, as described.

For instance, clusters are selected from the current population to serve as parents for the next generation. The selection process may be based on the fitness of individuals, where fitter individuals are more likely to be selected. Different selection mechanisms can be employed. One such example approach uses Boltzmann selection.

In general, Boltzmann selection is a variant of selection that introduces a probabilistic element inspired by the Boltzmann distribution from statistical mechanics. Here, the probability of an individual being selected can be determined by a probability distribution derived from the Boltzmann distribution.

Boltzmann selection introduces a balance between selecting fit individuals and exploring the solution space. Higher temperatures (T) encourage more exploration by making the selection process more random, while lower temperatures favor exploitation by emphasizing the selection of fitter individuals. The temperature can be adjusted to identify a balance between exploration and exploitation in the search space.

During crossover (recombination), pairs of parents are chosen, and their genetic material is exchanged to create new offspring. This mimics the idea of genetic recombination in natural evolution. A recombination rate may be set as a percentage between 0 and 1 based on the specific problem, and may vary so as to balance diversity with the rate of exploration of new solutions.

A mutation rate can be applied so that random changes are applied to some individuals in the population. The mutation rate is the probability that a given cluster will mutate during application of the genetic algorithm. It is usually a small number, as large-scale mutations may disrupt the evolutionary process. For example, with a mutation rate of 0.01 (or 1%), each cluster has a 1% chance of mutating each generation. A 1% mutation rate or less may be applied when employing the genetic algorithm. The rate can be constant or adaptive. An adaptive mutation rate can change over time based on the state of the population or following certain rules.

The fitness of each individual in the population is assessed based on an objective function of the problem being solved. For instance, the objective function may be to minimize route distance between the nodes of the cluster, minimize duration to traverse the route between nodes, minimize CO₂ output, or other desired objectives.

After evaluating the nodes, the nodes and some individuals from the current generation form the next generation, replacing less fit individuals. This ensures that the population evolves toward better solutions over time. As examples, replacement methods can include elitism, age-based replacement, fitness-based replacement, or other like replacement methods. In general, elitism involves preserving the best individuals from the current generation in the next generation without any modifications. These elite individuals are directly copied to the new generation, ensuring that the best solutions are not lost. The remaining slots in the population are filled with offspring from the crossover and mutation operations. In age-based replacement, each individual is assigned an age, and individuals are replaced based on their age. Older individuals are more likely to be replaced, which can help maintain diversity and prevent the population from converging prematurely. Fitness-based replacement selects individuals for replacement based on their fitness values. Individuals with lower fitness values are replaced, ensuring that the population is continually improving in terms of the objective function. One or a combination of these replacement methods may be used when employing the genetic algorithm.

The genetic algorithm may be applied over a defined number of epochs. Any number of epochs may be used. The defined number of epochs has a direct relationship with the amount of time necessary for employing the genetic algorithm, and may be set to balance between the time needed to employ the genetic algorithm and the robustness of the potential solutions. As an example, the defined number of epochs may be 100. The potential solutions at the end of the defined number of epochs may be used as the potential solutions input to the simulated annealing.

In an aspect, potential solution determiner 116 employs the genetic algorithm over a first timeframe. The first timeframe may be predetermined or determined dynamically. In aspects, the first timeframe is determined based on an average time to employ the genetic algorithm to its prior uses, such as those prior uses having a same number of nodes within node clusters. Thus, for example, if the average first timeframe for prior uses of the genetic algorithm for the same number of nodes in node clusters is two minutes, then potential solution determiner 116 may employ the genetic algorithm for two minutes to generate the potential solutions. The potential solutions at the end of the first timeframe may be used as the potential solutions input to the simulated annealing.

The potential solutions determined by potential solution determiner 116 can be further evolved using simulated annealing to find theoretically better routes between nodes. Simulated annealer 118 can be used to evolve each of the potential solutions to an evolved solution. In some cases, the evolved solution will be a more efficient route, e.g., based on distance or other metric, relative to those in the potential solutions.

Simulated annealing is a probabilistic technique used to find an approximate global optimum, i.e., the evolved solution. In simulated annealing, a solution is randomly selected and perturbed to create a new solution. If the new solution is better, the new solution is accepted. Otherwise, it's rejected. The probability that a new, better solution is found gradually decreases over time, reducing the likelihood of accepting worse solutions, and thus guiding the system toward the evolved solution. In this example, the evolved solution comprises each node assigned to a route (i.e., an evolved node cluster having nodes along a route). Simulated annealing may be performed in parallel, further speeding up the process in which route determiner 112 determines the optimal routes. In doing so, each node is assigned to an evolved node cluster, and may be in an order identifying a route through the nodes of the evolved node cluster.

To evolve the evolved node clusters, referred in this context as “chromosomes,” using simulated annealing, a dynamic cooling schedule may be applied. For example, a cooling schedule using a temperature (T) may be provided that Tₖ=a(k)Tₖ₋₁, where a(k)=best_fitness (Chromosome (k-2)/best_fitness (Chromosome (k-1)). Here, k is the iteration. The simulated annealing can end at a threshold change in temperature. As an example, this could be 5%. Thus, when the best_fitness (Chromosome (k))-worst_fitness (Chromosome (k))/100<0.05, the simulated annealing can end. As noted, the process may be iterative with the genetic algorithm, and thus, when T reaches the threshold, the process may continue back by using the final output of the simulated annealing as the input population for the genetic algorithm.

In an aspect, the simulated annealing is employed until a threshold temperature (T) is met. In such cases, this may include a change in the constraint density threshold temperature (T). For example, if the change is below a threshold temperature (T) change, then the simulated annealing process may be completed. In aspects, the simulated annealing process continues until the change in the temperature (T) is below the threshold value for a consecutive number of times. Any consecutive number of times may be provided, but in one suitable embodiment, five can be used. That is, the simulated annealing process may stop after the temperature (T) is below the threshold temperature (T) value for the threshold number of times. At such time, the evolved solutions may be provided back to the genetic algorithm to continue the iterative process (e.g., to complete another iteration) or may be provided to the quantum annealer to anneal the evolved node clusters of an evolved solution.

In aspects, the simulated annealing may be performed for a second timeframe. The second timeframe may be based on an average second timeframe to employ the simulated annealing in prior uses. For instance, this may include prior uses of the simulated annealing for a same number of nodes.

Quantum annealer invoker 120 may be employed to invoke quantum annealer 110 to identify the optimal routes for an evolved solution. As noted, the evolved solution may include a plurality of evolved node clusters, with each evolved node cluster having nodes through which a route may be identified. The quantum annealer may be invoked to anneal each evolved node cluster separately. In this way, the optimal route through the nodes in each evolved node cluster is identified. Thus, in an aspect, an evolved node cluster of the evolved solution comprises a set of nodes. During the annealing process by the quantum annealer, the optimal route is identified through the set of nodes, where each node of the set lies along the route. Thus, for instance, the set of nodes for the evolved node cluster is the same as the set of nodes for the evolved node cluster after the annealing process, although the order in which the nodes appear on a route may be different, as the quantum annealer identifies the optimal route through the set of nodes.

The evolved solution, which will be annealed using the quantum annealer, may be selected from a plurality of evolved solutions output by the simulated annealing process. As an example, evolved solution may be selected based on a minimum total route distance. That is, the distance of each route for each evolved node cluster can be summed to determine, for each evolved solution, the total route. The evolved solution having the minimum total route distance may be selected for the quantum annealing. Other variables may be used, such as the total time to traverse the routes of the evolved solutions, the CO₂ emitted to traverse the routes of the evolved solutions, etc. Thus, for example, the evolved solution having the total minimum time or CO₂ emissions may be selected. These are just some examples, and other variables may be chosen to select the evolved solution for the quantum annealing process. The quantum annealer may be invoked or otherwise employed, as will be further described. Quantum annealing may done in parallel, e.g., solving each routing problem (i.e., each evolved node cluster of an evolved solution) separately, for instance, in parallel.

In aspects, invoking the quantum annealer may include providing an objective and one or more constraints for solving for the optimal route. A quadratic formulation may leverage the quadratic nature of the CQM (Constrained Quantum Models) solver.

Example parameters may include:
Cᵢⱼ: distance or cost to travel from location i to location j.
Dⱼ: demand requirement for customer j.
Q: individual capacity for each vehicle (or route).
Nₖ: size of cluster k.

Decision Variables
Xᵢₜ: binary, indicating whether node i is visited at step t.

Some example constraints can include:

Only one destination can be visited at each time step:

$${\sum }_{i = 1}^{{N}_{k}} {x}_{it} = 1 , ∀ t ∈ \{ 1 , … , {N}_{k} \} .$$

Some objectives could include minimizing the total route cost or distance. An example is given by the following function:

$$min {\sum }_{t = 1}^{{N}_{{k}^{- 1}}} {\sum }_{i , j} {C}_{ij} {x}_{ik} {x}_{j , t + 1} + {\sum }_{i} ( {C}_{0 i} {x}_{i 1} + {c}_{i 0} {x}_{{iN}_{k}} ) .$$

In an aspect, a total time threshold may be accessed. The total time threshold may identify a total time in which route determiner 112 may execute potential solution determiner 116, simulated annealer 118 and quantum annealer invoker 120 to determine the optimal routes. For instance, this may be provided by a user that has a limited amount of time to determine the most optimal routes possible within the total time threshold. As such, route determiner 112 may identify and provide optimal routes at or within the accessed total time threshold.

One example method for determining optimal routes within the total time threshold determines or otherwise accesses an average first timeframe over which the genetic algorithm is employed. Likewise, the average second timeframe over which the simulated annealing is employed may be determined or otherwise accessed. A third timeframe during which the quantum annealer determines the optimal routes may also be accessed. This could be based on prior uses of the quantum annealer for clusters having a same number of nodes.

Having this information, a number of iterations during which the genetic algorithm and the simulated annealing process are employed is determined from an average of the first timeframe and the second timeframe over the iterations, the third timeframe, and a total time threshold. Thus, for instance, the number of iterations may be determined by determining the remaining time within the total time threshold using an average third timeframe. The number of iterations is then based on the remaining time, e.g., the number of iterations of the genetic algorithm and the simulated annealing that can be performed using the average first timeframe and average second timeframe within the remaining time. Once the number of iterations has been performed, the evolved solution can be provided to the quantum annealer, which anneals the evolved solution within the total time threshold.

The optimal routes determined by the quantum annealer may be assigned to a vehicle available to traverse the route. Thus, for example, each optimal route may be assigned to one or more vehicles.

In some cases, the number of vehicles available to traverse the optimal routes is less than the number of optimal routes identified. In such cases, the evolved node clusters for which the optimal routes have been identified may be combined. This may be done to match the number of vehicles available to traverse the routes. Thus, for instance, at least a portion of the evolved node clusters for which optimal routes have been generated by the quantum annealer may be combined such that the combining of the evolved node clusters reduces a number of evolved node clusters of the selected evolved solution to match a number of vehicles available to traverse the optimal routes. In an example, the evolved node clusters may be combined in such a manner to decrease the total distance a vehicle travels when traversing the optimal routes of the combined evolved node clusters.

One example method includes identifying the cluster centroid for each of the evolved node clusters for which the optimal routes have been identified. As noted, the nodes represent locations, and each location has a position relative to the other locations. As such, a centroid for the evolved node cluster can be determined based on their relative distances. The centroid therefore has a corresponding position, and each centroid location may be compared to the centroid positions and combined on the distance between the cluster centroids. Evolved node clusters having the closest cluster centroids may be combined. This helps derive combined optimal routes that can be traversed by one of the vehicles. In aspects, a number of evolved node clusters having optimal routes identified by the quantum annealer can be combined such that the total number of routes and combined optimal routes matches the number of vehicles available to traverse the routes and combined optimal routes.

This clustering and routing approach lowers complexity for a given problem size: in an example, the clustering problem has KN binary variables and the routing problems have N_{K2} binary variables. This empowers the solver to address significantly more extensive problem instances than it would have been capable of otherwise, leading to the discovery of solutions of exceptional quality and improved solutions over conventional methods.

In one aspect, the optimal routes can be communicated to a fleet of vehicles that navigate the routes in response to the communication. In another aspect, the optimal routes are communicated as routing instructions to a fleet of more than one autonomous vehicle, where each autonomous vehicle of the fleet navigates through the nodes of the respective optimal route in accordance with the communicated routing instructions.

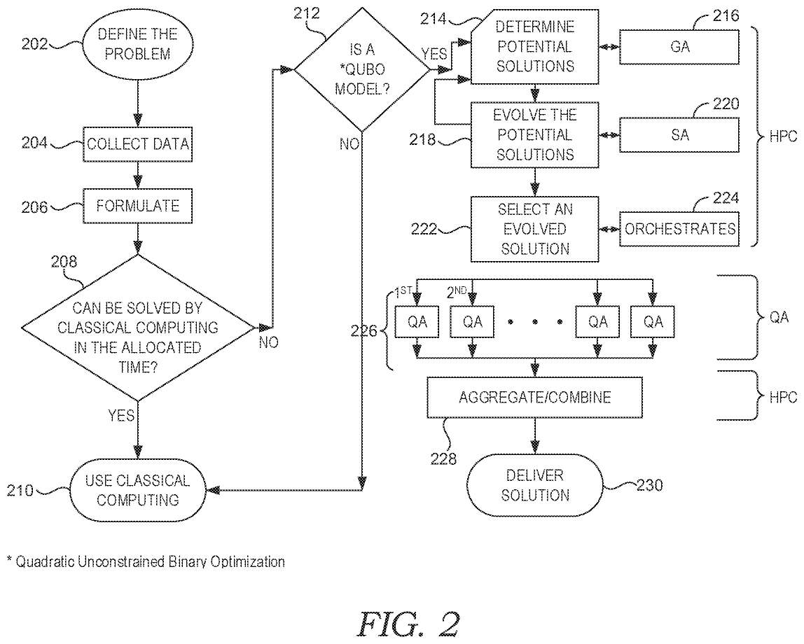

FIG. 2 illustrates a flow diagram of an example process that can be performed using components of FIG. 1. At 202, the problem can be defined. For example, this may include defining the objective and constraints of the problem. These may be defined, e.g., a vehicle routing problem. At 204, data is collected. This may include collecting data for parameters that are terms in which the problem was defined, such as locations (i.e., nodes), vehicles, cost of transporting, vehicle types, fuel consumption, carbon dioxide emissions, and so forth. Objectives might include minimizing or maximizing any combination of any of these or other examples. At 206, the problem may be formulated in mathematical notation, e.g., identifying the relationships between the parameters and operators to minimize or maximize certain parameters, for example.

In this example illustrated, a determination is made at 208 whether the problem formulated at 206 can be solved using a classical computing device. A computation threshold may be applied for the determination. That is, problems requiring a level of computing processing power below the computational threshold (representing a suitable time and processing of a classical computing device) may be solved by a classical computing device at 210. Those problems where the solution requires computer processing power above the computational threshold of the classical computing device may further be analyzed for solving via a quantum computing device, such as a quantum annealer, at 212. At 212, if the problem can be written as a QUBO problem or other like model suitable for the quantum annealer, such as Ising, the process proceeds to using quantum computing to determine the optimal routing solution. If the problem cannot be formatted using a model suitable for a quantum computing device, the process could continue to 210 where the problem is processed using a classical computing device.

If yes, the process may continue with a hybrid classical-quantum process for determining the optimal solution by proceeding to 214. At 214, initial candidate solutions (also referred to as potential solutions) are determined. The potential solution may be determined by employing the genetic algorithm 216 on an initial set of clustered nodes or from a set of evolved solutions determined by the simulated annealer 220 in a prior iteration. The genetic algorithm, as illustrated at 216, may be applied using potential solution determiner 116 to output the potential solutions.

The potential solutions determined at 214 may be evolved at 218 further using simulated annealing 220. This may be done using simulated annealer 118. The output of the simulated annealer are evolved solutions. The potential solutions determined at 214 and the evolved solutions determined at 218 may be iteratively performed, meaning that the output evolved solutions by the simulated annealing 220 may be used as the input clusters for the genetic algorithm 216.

After a final iteration of evolving the potential solution into evolved solutions, an evolved solution is selected for annealing at 222. As described, an evolved solution comprises evolved node clusters. The evolved solution can be selected based on a shortest total distance between the nodes of the routes identified by each evolved node cluster in the evolved solutions.

Continuing, a classical computing device may orchestrate, as shown in 224, splitting the evolved node clusters of the selected evolved solution into k optimization problems, e.g., traveling salesman problems (TSPs). That is, each evolved node cluster of the evolved solution may be treated as a separate problem for identifying the optimal route between the nodes of each evolved node cluster. At 226, each of the k problems is parallel-processed using a quantum annealer according to defined objectives and constraints. The output of the quantum annealing is an optimal route through the nodes within each evolved node cluster. In some cases, the optimal routes may be aggregated (i.e., combined) at 228 and provided as the optimal routing solution at 230 for each available vehicle.

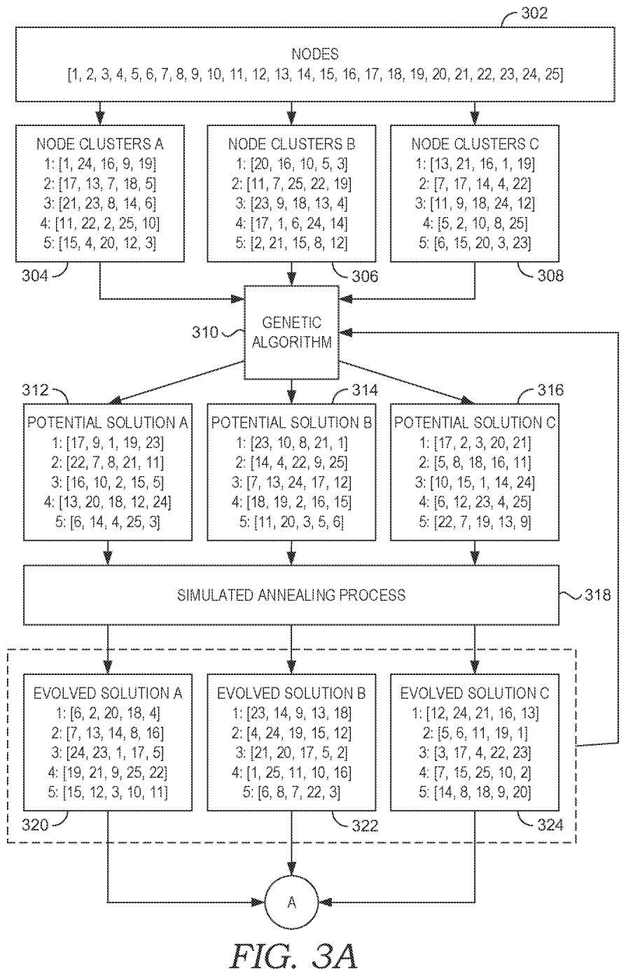

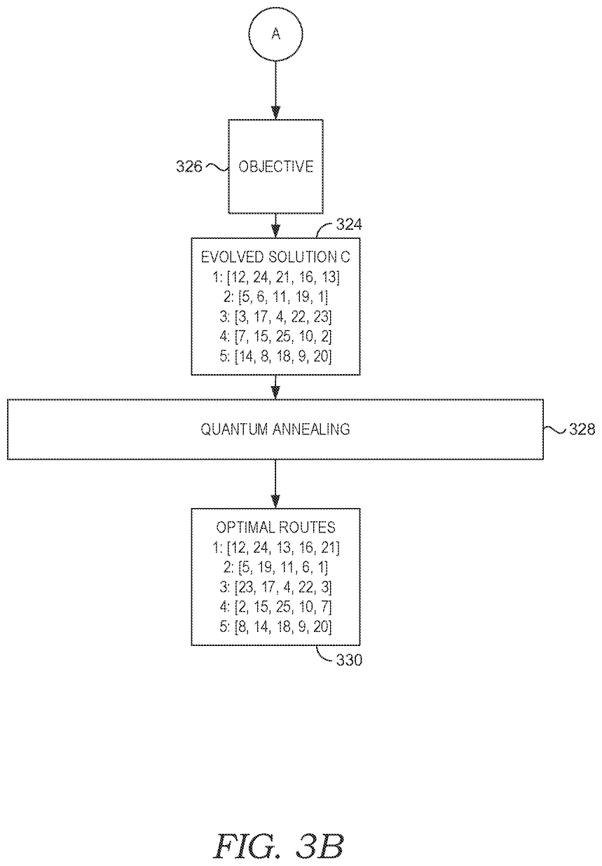

FIGS. 3A and 3B further help illustrate an example in which optimal routes are determined and combined using the components of FIG. 1. As illustrated, nodes 302 can be clustered using clustering engine 114. These may be clustered to provide a number of node clusters that each have a number of nodes according to a constraint density threshold of a quantum annealer, in an example. In some cases, objectives and constraints may be applied when clustering the nodes into the node clusters, while in other cases, the clustering may be random. As illustrated, the output of the clustering of nodes 302 includes node clusters A 304, node clusters B 306, and node clusters C 308. It will be realized that this is an example using 25 nodes, and that only three groups of node clusters have been illustrated. In general, this may scale to any size based on the number of nodes.

The node clusters are input to genetic algorithm 310, which generates potential solutions. This may be done using potential solution determiner 116. Each potential solution may include a plurality of refined node clusters. In the example illustrated, genetic algorithm 310 outputs three potential solutions: potential solution A 312, potential solution B 314, and potential solution C 316. Each of the refined node clusters may include nodes having an order identifying a route through the nodes. As an example, the route illustrated through refined node cluster number one of potential solution A 312 includes nodes 17, 9, 1, 19, and 23 in that ordered sequence.

Each of the potential solutions generated by genetic algorithm 310 in the illustrated example is provided as an input to simulated annealing process 318. The simulated annealing process 318 generates evolved solutions and may be performed using simulated annealer 118. Each evolved solution may include evolved node clusters. Each evolved node cluster includes nodes having an order identifying a route. Theoretically, the route of the evolved node clusters are to better fit the objectives, such as minimizing distance, time, cost, CO₂, etc., compared to those routes of the potential solutions. In this example, simulated annealing process 318 outputs three evolved solutions: evolved solution A 320, evolved solution B 322, and evolved solution C 324. As such, in the example, the route illustrated through evolved node cluster number one of evolved solution A 320 includes nodes 6, 2, 20, 18, and 4 in that ordered sequence.

As illustrated, the evolved solutions generated by simulated annealing process 318 may be provided back as an input to genetic algorithm 310 during an iterative process, with each iteration comprising employing genetic algorithm 310 and simulated annealing process 318. This may continue until a determined time is met or other metric, such as temperature (T) during the simulated annealing process 318, is satisfied.

An evolved solution may be selected from the final evolved solutions, such as evolved solution A 320, evolved solution B 322, and evolved solution C 324. Moving to FIG. 3B, each of the evolved solutions is compared relative to objective 326. The objective 326 may include minimizing the total distance between nodes, the total time for a vehicle to traverse through the routes of the nodes, the minimum CO₂ amount, and so forth. One specific example uses the total route distance through the nodes of the evolved node clusters within each evolved solution. Thus, for example, objective 326 may select the evolved solution having the minimum total route distance. In the illustrated example, using objective 326, evolved solution C 324 has been selected.

To determine optimal routes for evolved solution C 324, each of the evolved node clusters 1-5 can be separately annealed via quantum annealing 328 according to a set of objectives and constraints. Quantum annealer invoker 120 can be used to invoke a quantum annealer, such as quantum annealer 110, to perform quantum annealing 328. Through the quantum annealing process, an optimal route for each of the evolved node clusters is determined, illustrated as optimal routes 330. Since each evolved node cluster is annealed as its own traveling salesman problem, quantum annealing 328 determines the optimal route through the nodes of each respective evolved node cluster. For example, the optimal route for the evolved node cluster number 1 includes nodes 12, 24, 13, 16, and 21 in that ordered sequence.

In aspects, each optimal route of optimal routes 330 is provided to a vehicle to traverse the route. In some cases, one or more of the evolved node clusters having identified optimal routes may be combined so that the total number of optimal routes matches a number of available vehicles.

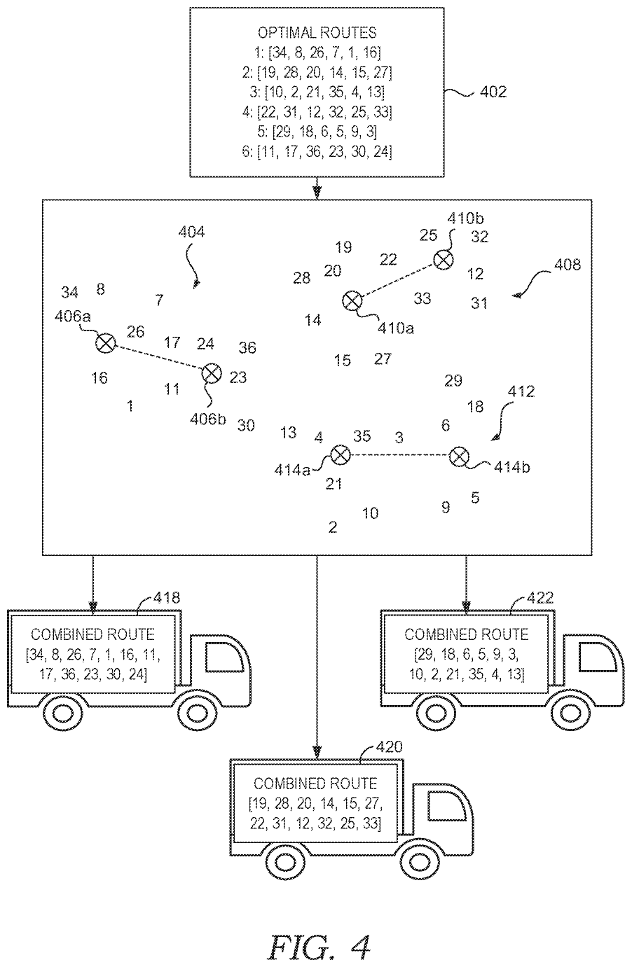

An example combination of optimal routes is illustrated in FIG. 4. Here, optimal routes 402 comprises evolved node clusters for which optimal routes have been identified, for instance, using the process described with respect to FIG. 2 or FIGS. 3A-3B. In this example, each evolved node cluster comprises nodes for which a cluster centroid can be determined, since each node represents a location having a position relative to each of the other nodes.

In the example, the evolved node cluster number 1 within optimal routes 402 has a cluster centroid determined as cluster centroid 406a. Similarly, the evolved node cluster number 2 has a cluster centroid determined as cluster centroid 410a, while cluster centroid 414a has been determined for number 3, cluster centroid 410b for number 4, 414b for number 5, and cluster centroid 406b for number 6.

Each of the cluster centroids has a position relative to the other cluster centroids. The distance between each cluster centroid can be determined, and the evolved node clusters for which the optimal routes have been identified can be combined based on the determined distances. In an example, those cluster centroids having the shortest distance are combined. In the example illustrated, cluster centroid 406a and cluster centroid 406b have been combined to form combined cluster A 404. Cluster centroid 410a and cluster centroid 410b have been combined to form combined cluster B 408. Cluster centroid 414a and cluster centroid 414b have been combined to form combined cluster C 412.

As such, in this example, the evolved node clusters for which optimal routes have been identified have been combined so that the number of routes and combined routes of the combined evolved node clusters matches a number of vehicles available to traverse the routes and combined routes. As illustrated, combined route 418, combined route 420, and combined route 422 may each be provided to a vehicle for servicing the routes.

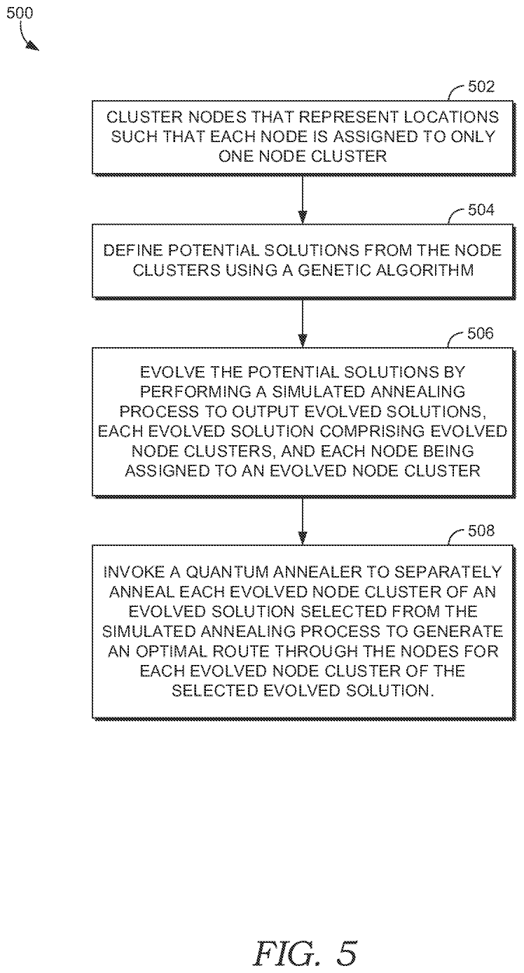

With reference back to FIG. 5, a block diagram is provided illustrating method 500 for determining optimal routes using a hybrid classical-quantum system. Each block of method 500 may comprise a computing process performed using any combination of hardware, firmware, or software. For instance, various functions can be carried out by a processor executing instructions stored in memory. The method can also be embodied as computer-usable instructions stored on computer storage media. The method can be provided by a standalone application, a service or hosted service (standalone or in combination with another hosted service), or a plug-in to another product, to name a few possibilities. Method 500 may be implemented in whole or in part by components of operating environment 100.

In block 502, method 500 clusters nodes that represent locations such that each node is assigned to only one node cluster. In an aspect, each cluster of nodes may correspond to a vehicle for which an optimal route is to be determined. In an aspect, the clustering clusters nodes such that each node cluster is assigned one node cluster. This may be performed using clustering engine 114.

In block 504, method 500 defines potential solutions from the node clusters using a genetic algorithm. The node clusters input to the genetic algorithm may be the node clusters provided using clustering engine 114. For instance, these may be initial node clusters. In aspects, the node clusters provided to the genetic algorithm are evolved node clusters determined at block 506, as performed as part of an iterative process. The potential solutions may be determined by the genetic algorithm using potential solution determiner 116.

In block 506, method 500 evolves the potential solutions by performing a simulated annealing process to output an evolved solution, the evolved solution comprising each node assigned to an evolved node cluster that identifies a route through the nodes of the evolved node cluster. This may be performed using simulated annealer 118.

In block 508, method 500 invokes a quantum annealer to separately anneal each evolved node cluster of an evolved solution selected from the evolved solutions generated at block 506. The quantum annealing may be performed using quantum annealer 110 as invoked by quantum annealer invoker 120 to generate an optimal route through the nodes for each evolved node cluster. In an aspect, each evolved node cluster is annealed in parallel. The quantum annealer determines the optimal route through each of the nodes within each evolved node cluster of the selected evolved solution according to a set of objectives and constraints.

A quadratic model from an objective function and a set of constraints may be generated for use by the quantum annealer to determine the optimal solution. In an aspect, the objective function minimizes the total distance within each group of nodes. Other objectives may be used, including cost minimization, fuel minimization, carbon dioxide minimization, or another objective. In one example implementation, at least one constraint restricts the objective function such that each node occurs only once in a route determined for a group of nodes for a vehicle.

The optimal routes may be provided to respective vehicles for traversing the optimal routes. In aspects, combined optimal routes are generated by combining evolved node clusters for which optimal routes have been identified to match a number of available vehicles for servicing the routes or combined routes. These may be done by combining evolved node clusters having cluster centroids with the shortest distance.

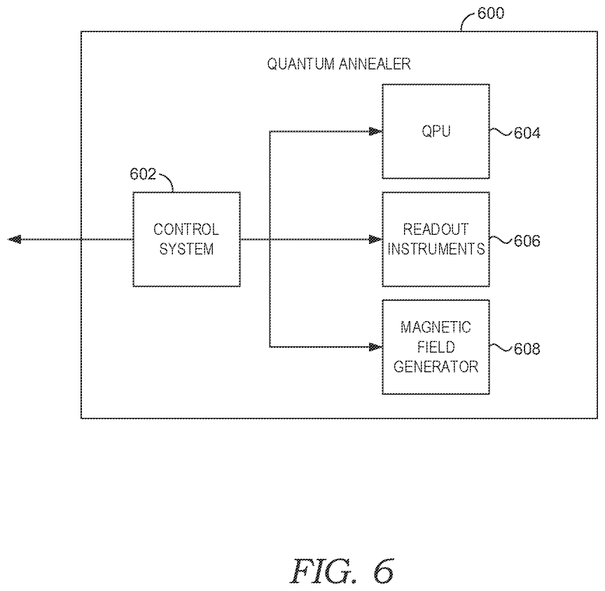

FIG. 6 illustrates an example quantum annealer 600 that may be employed with aspects of the technology. As FIG. 6 is only one example, other quantum annealers may be employed. Some examples of which may include D-Wave Systems annealers, which employ superconducting qubits to find the optimal or near-optimal ground state solutions to solving proposed optimization problems. As such, other quantum annealers having more of fewer components, and having different arrangements or architectures, may be used. It is again noted that the illustrated quantum annealer 600 in FIG. 6 is only an example and is provided to aid in the description of the technology. It is not intended to limit the technology to one type of quantum annealer, or any type of quantum computing system. In the example provided, quantum annealer 600 comprises control system 602 operationally coupled to QPU 604, readout instruments 606, and magnetic field generator 608.

Control system 602 of quantum annealer 600 generally interfaces with components of quantum annealer 600, including QPU 604, readout instruments 606, and magnetic field generator 608, among other components not illustrated. For instance, control system 602 may operationally control or receive information from such components. Control system 602 facilitates quantum annealing functions, for example, translating a quantum problem into physical aspects of the QPU 604; setting parameters of the quantum annealing process, including the biases and couplings among qubits; and managing the annealing schedule, a predefined protocol guiding the system from the initial to the final Hamiltonian that finds the global minimum representing the quantum problem's solution, among other functions and operations.

During the annealing process, control system 602 generates and delivers signals to the qubits and couplers of QPU 604, manipulating their states and interactions in accordance with the quantum problem being executed. In aspects, as the annealing process concludes, control system 602 may oversee the readout of qubits' states in coordination with readout instruments 606, thus translating quantum information into classical data that can be interpreted by classical computing devices.

Control system 602 may provide an interface for external systems by communicatively coupling with classical computing devices, such as computing device 800 of FIG. 8, to facilitate the input of problem definitions and the output of solutions. Control system 602 itself may comprise a classical computer processor that reads from memory to execute computer-readable instructions stored thereon.

QPU 604 (i.e., a Quantum Processing Unit) is the core of quantum computational activity. QPUs may house an array of qubits (quantum bits), which may exist in a superposition of states. QPU 604 facilitates quantum operations that exploit quantum phenomena like superposition and entanglement to solve quantum problems. Within QPU 604, couplers manage interactions between the qubits and form the basis for quantum logic gates and multi-qubit operations for quantum algorithms. Although not illustrated, QPU 604 may be cooled by a cooling device of quantum annealer 600 and shielded from other external components or interferences, helping to maintain quantum coherence.

QPU 604 may comprise control lines, across which signals are transmitted, that guide quantum operations of QPU 604. QPU 604 may couple to readout instruments 606 to translate quantum states into classical data and communicate control system 602. Readout instruments 606 may include an analog-to-converter that translates the quantum state of the qubits to the digital space, thereby identify the quantum state of the qubits in a manner readable by a classical machine, thus providing a candidate solution for the quantum problem to control system 602. In aspects, analog signals captured from qubit measurements may be amplified and filtered to sift through and eliminate noise.

Qubit states may be manipulated by control system 602 employing magnetic field generator 608. By varying the strength and orientation of the magnetic field, control system 602 can tailor the energy landscape that the qubits navigate during the annealing process. This magnetic field induces a bias on each qubit, influencing its tendency to take on a particular state during the annealing process.

The construction of quantum computers can be approached through various paradigms and hardware setups, among which gate-based quantum computing and adiabatic quantum computation (AQC) are predominant. Gate-based computing involves executing computations by applying a series of unitary gates to quantum bits (qubits), which are then measured at the computation's conclusion. Conversely, AQC starts with a many-qubit quantum state prepared as a simple Hamiltonian's ground state, which, through adiabatic time evolution, transitions to a final Hamiltonian, encoding the solution to a targeted optimization problem. AQC and gate-based quantum computing are polynomially equivalent since quantum circuits can be depicted as a time-dependent Hamiltonian with a maximal polynomial overhead.

Quantum annealing (QA) is closely related to AQC. QA is a variant of the AQC model, employed when adiabatic conditions are unfulfilled, leading to a heuristic variational quantum algorithm. This technique is adept at identifying the ground state of Ising models, an NP-hard challenge. NP-hard and NP-complete combinatorial optimization problems can be transformed to forms suitable for quantum annealers, either framed in Ising form or as a Quadratic Unconstrained Binary Optimization (QUBO) problem. For instance, these optimization problems can be transformed to Ising form using a {−1,1} basis and spin variables or as a QUBO problem using the {0, 1} basis and binary variables. In QA, solving an optimization problem entails progressing through multiple stages, with the specifics of each stage being influenced by the kind of qubits utilized, the adiabatic protocol implemented, and other engineering factors.

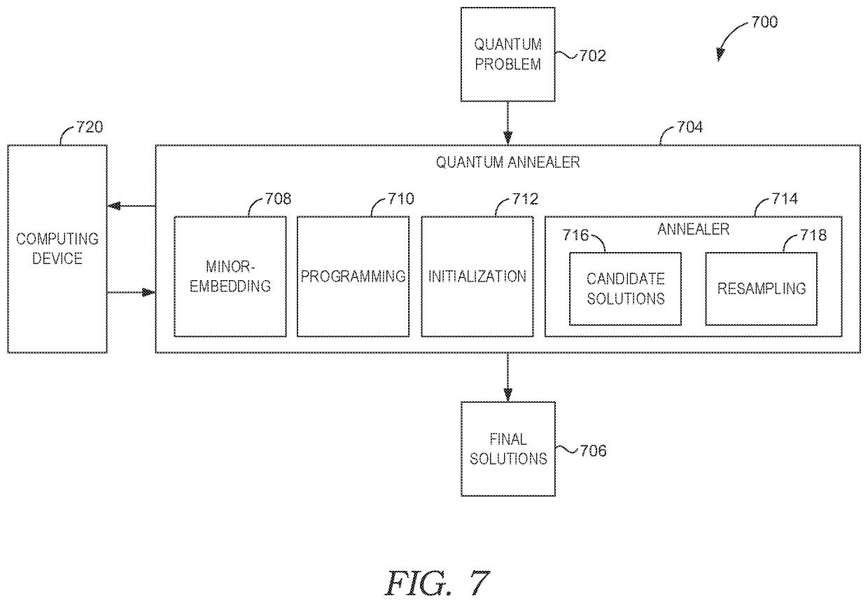

FIG. 7 illustrates an example quantum annealing process 700 utilizing quantum annealer 704. FIG. 7 is only one example provided as an aid for understanding and using the technology described herein. At a high level, quantum annealer 704 receives an input, illustrated using example quantum problem 702 and outputs candidate final solution(s) 706. Quantum annealing process 700 illustrates processes 708-718 that may be performed by or for quantum annealer 704 to determine final solution(s) 706. For instance, some aspects may be performed by a classical computing device 720 communicatively coupled to quantum annealer 704. As an example, the classical computing device 720 may be used to facilitate aspects of minor-embedding process 708, programming process 710, and initialization process 712 in coordination with quantum annealer 704. Computing device 800 of FIG. 8. is an example suitable for use as computing device 720. Computing device 720 may interface with a control system of quantum annealer 704, which may be the same or separate computing device. As with other aspects of FIG. 7, each step of the process is intended to represent an example, and nothing is intended to restrict the technology to a particular process or machine.

Having this in mind, quantum problem 702 may include optimization problems in various forms, such as a QUBO model and an Ising model. Real-world problems can be broken down into objectives and constraints. Optimization problems can be represented by the following QUBO form:

$$min ( {\sum }_{i} {a}_{i} {x}_{i} = {\sum }_{i} {\sum }_{j > i} {b}_{i , j} {x}_{i} {x}_{j} + c ) .$$

The binary variables xᵢ and xⱼ may take values from {0, 1}, and aᵢ, bᵢ, and c are constraints defined by the problem to be solved.

Optimization problems may be expressed by the Ising model, taking the following form:

$$min ( {\sum }_{i} {h}_{i} {s}_{i} = {\sum }_{i} {\sum }_{j > i} {J}_{i , j} {s}_{i} {s}_{j} ) .$$

The binary variables sᵢ and sⱼ may take values from {−1,1}, whereas J_{i,j} is the interaction of two adjacent sites <i,j> for a given magnetic field hi. The QUBO form and the Ising form may be translated from one another in some cases.

The models may be represented by a logical graph. For a QUBO problem, each node may correspond to a variable, which may correspond to qubits. Edges in this graph represent the interaction terms between pairs of variables, derived from the quadratic terms in the QUBO expression. Similarly, for an Ising model, each node may represent a spin and correspond to qubits. Edges may denote the interactions between pairs of spins (or variables) as dictated by the interaction terms in the Ising model's energy expression. Such models may be formulated or represented as a logical graph and provided as a quantum problem 702 to quantum annealer 704.

During minor-embedding process 708, the local graph of the initial quantum problem 702 may be translated onto the physical hardware of the quantum processing unit (QPU). Here, select sets of physical qubits represent the nodes, while couplings between the qubits correspond to the interaction of the logical variables.

During programming process 710, the quantum annealer 704 may be programmed with the parameters that define the problem. This problem may be the final Hamiltonian. The final Hamiltonian is a quantum mechanical operator that represents the problem to be solved in a form that quantum annealer 704 understands. It is derived from the logical representation of the problem (such as the QUBO formulation or the Ising model). The objective is to find the state (or configuration of qubits) that minimizes its energy as this corresponds to the solution of quantum problem 702.

The programming process 710 may comprise setting weights for each qubit bias and coupler strength. Qubits in quantum annealer 704 can have a bias, for example, a term in the final Hamiltonian that represents an external magnetic field acting on the qubit. Setting the bias on a qubit influences its tendency to take a particular state (0 or 1). Weights for the qubit bias may be set based on the problem formulation to guide quantum annealer 704 toward the desired solution. Couplers may comprise elements in quantum annealer 704 that control the interaction between pairs of qubits. The strength of a coupler determines the extent to which the state of one qubit influences the state of another. Coupler strength may be set to represent the interactions between variables in quantum problem 702.

During initialization process 712, an initial Hamiltonian may be defined. The initial Hamiltonian may be constructed to have an achievable lowest energy (ground state) configuration. The design may serve as a starting point for the annealing process 714.

Through annealing process 714, quantum annealer 704 gradually transitions from the initial Hamiltonian to the final Hamiltonian (which was defined during the programming phase and represents the actual problem to be solved). Generally, as the system transitions, quantum annealer 704 attempts to maintain the lowest-energy configuration, and ideally ends in the ground state of the final Hamiltonian, which corresponds to the solution of the quantum problem 702. In some cases, annealing process 714 can also be combined with a reverse annealing phase, which initializes quantum annealer 704 with a known (classical) solution and searches the state space around this local optimum.

At the end of annealing process 714, quantum annealer 704 provides candidate solutions 716 to quantum problem 702. Here, the qubits in the QPU are in an eigenstate or a superposition of eigenstates with respect to the final Hamiltonian. An eigenstate refers to a state with a well-defined energy and represents a possible solution. A superposition of eigenstates refers to multiple eigenstates at once, each representing a potential solution to the problem. Each qubit's spin (either up or down) is read out, and the collection of spin values represents a candidate solution to quantum problem 702.

Quantum annealing is heuristic and the exact optimal solution (ground state of the final Hamiltonian) may not be found in every run. Instead, the candidate solutions 716 provide a good enough solution in a reasonable amount of time. Naturally, there's a non-zero probability of ending up in a non-optimal solution due to various quantum phenomena like tunneling and thermal fluctuations. As such, annealing process 714 may undergo resampling 718, which repeats the annealing process 714 in an effort to identify a better solution than prior candidate solutions 716. Each resampling process provides a new opportunity for the quantum annealer 704 to explore the solution space and possibly find a better or different candidate solution. Resampling 718 may be performed as many times as desired, as time and continued benefit allow. By comparing candidate solutions 716, the best candidate solution, or even a variety of candidate solutions, may be chosen as solutions to quantum problem 702 and output as final solution(s) 706.

Having described an overview of some embodiments of the present technology, an example computing environment in which embodiments of the present technology may be implemented is described below in order to provide a general context for various aspects of the present technology. Referring now to FIG. 8 in particular, an example operating environment for implementing embodiments of the present technology is shown and designated generally as computing device 800. Computing device 800 is but one example of a suitable computing environment and is not intended to suggest any limitation as to the scope of use or functionality of the technology. Computing device 800 should not be interpreted as having any dependency or requirement relating to any one or combination of components illustrated.

The technology may be described in the general context of computer code or machine-useable instructions, including computer-executable instructions, such as program modules, being executed by a computer or other machine, such as a cellular telephone, personal data assistant, or other handheld device. Generally, program modules, including routines, programs, objects, components, data structures, etc., refer to code that performs particular tasks or implements particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 8, computing device 800 includes bus 802, which directly or indirectly couples the following devices: memory 804, one or more processors 806, one or more presentation components 808, input/output (I/O) ports 810, input/output components 812, and illustrative power supply 814. Bus 802 represents what may be one or more buses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 8 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 8 and with reference to “computing device.”

Computing device 800 typically includes a variety of computer-readable media. Computer-readable media can be any available media that can be accessed by computing device 800 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM, ROM, EEPROM, flash memory, or other memory technology; CD-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 800. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 804 includes computer storage media in the form of volatile or non-volatile memory. The memory may be removable, non-removable, or a combination thereof. Example hardware devices include solid-state memory, hard drives, optical-disc drives, etc. Computing device 800 includes one or more processors that read data from various entities, such as memory 804 or I/O components 812. Presentation component(s) 808 presents data indications to a user or other device. Example presentation components include a display device, speaker, printing component, vibrating component, etc.

I/O ports 810 allow computing device 800 to be logically coupled to other devices, including I/O components 812, some of which may be built-in. Illustrative components include a microphone, joystick, game pad, satellite dish, scanner, printer, wireless device, etc. The I/O components 812 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition, both on screen and adjacent to the screen, as well as air gestures, head and eye tracking, or touch recognition associated with a display of computing device 800. Computing device 800 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 800 may be equipped with accelerometers or gyroscopes that enable detection of motion. The output of the accelerometers or gyroscopes may be provided to the display of computing device 800 to render immersive augmented reality or virtual reality.

At a low level, hardware processors execute instructions selected from a machine language (also referred to as machine code or native) instruction set for a given processor. The processor recognizes the native instructions and performs corresponding low-level functions relating, for example, to logic, control, and memory operations. Low-level software written in machine code can provide more complex functionality to higher levels of software. As used herein, computer-executable instructions includes any software, including low-level software written in machine code; higher-level software, such as application software; and any combination thereof. In this regard, functional components of FIG. 1 can manage resources and provide the described functionality. Any other variations and combinations thereof are contemplated within embodiments of the present technology.

With reference briefly back to FIG. 1, it is noted and again emphasized that any additional or fewer components, in any arrangement, may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Although some components of FIG. 1 are depicted as single components, the depictions are intended as examples in nature and in number and are not to be construed as limiting for all implementations of the present disclosure. The functionality of operating environment 100 can be further described based on the functionality and features of its components. Other arrangements and elements (e.g., machines, interfaces, functions, orders, and groupings of functions, etc.) can be used in addition to or instead of those shown, and some elements may be omitted altogether.

Further, some of the elements described in relation to FIG. 1, such as those described in relation to route determiner 112, are functional entities that may be implemented as discrete or distributed components or in conjunction with other components, and in any suitable combination and location. Various functions described herein are being performed by one or more entities and may be carried out by hardware, firmware, or software. For instance, various functions may be carried out by a processor executing computer-executable instructions stored in memory, such as database 106. Moreover, functions of route determiner 112, among other functions, may be performed by server 102, computing device 104, or any other component, in any combination.

Referring to the drawings and description in general, having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (e.g., machines, interfaces, functions, orders, and groupings of functions, etc.) can be used in addition to or instead of those shown.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including,” “having,” and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving” or “transmitting,” as facilitated by software or hardware-based buses, receivers, or transmitters” using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

As used herein, the term “computing device” is intended to refer to a classical computing device, such as computing device 800 of FIG. 8. Other related terms, including “client device,” “server,” and the like are similarly intended to refer to a classical computing device. Terms that include “quantum” are intended to refer to a quantum computing device, such as a quantum annealer. An example quantum computing device is illustrated and described with respect to FIG. 6.

An optimal solution (also referred to as optimal packing arrangement), as described herein is intended to be the most favorable solution derived from a set of potential solutions generated within the constraints of available processing power and time. This solution minimizes or maximizes the defined objective(s) based on the data and algorithms employed during the computational process, such as the annealing process. It represents the best solution among those explored, within the computational resources allocated, to solve the optimization problem and achieve the desired logistical outcome. While it may not represent the absolute best solution possible due to limitations in computational resources, data accuracy, or physical interferences, it stands as the most efficient or effective solution identified through the computational process undertaken for a given set of parameters.

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well-adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

Some aspects of the technology that may be practice from the foregoing description include, but are not limited to, the following:

Aspect 1: A computerized method comprising: clustering nodes that represent locations such that each node is assigned to only one node cluster; determining potential solutions from the node clusters using a genetic algorithm; evolving the potential solutions by performing a simulated annealing process to output evolved solutions, each evolved solution comprising evolved node clusters, and each node being assigned to an evolved node cluster; and invoking a quantum annealer to separately anneal each evolved node cluster of an evolved solution selected from the simulated annealing process to generate an optimal route through the nodes for each evolved node cluster of the selected evolved solution.

Aspect 2: A system comprising: a quantum annealer; at least one processor; and one or more computer storage media storing computer-readable instructions thereon that when executed by the at least one processor cause the at least one processor to perform operations comprising: determining potential solutions from node clusters having nodes that represent locations using a genetic algorithm; evolving the potential solutions by performing a simulated annealing process to output evolved solutions, each evolved solution comprising evolved node clusters, and each node being assigned to an evolved node cluster; and invoking the quantum annealer to separately anneal each evolved node cluster of an evolved solution selected from the simulated annealing process to generate an optimal route through the nodes for each evolved node cluster of the selected evolved solution.

Aspect 3: One or more computer storage media storing computer-readable instructions thereon that when executed by a processor cause the processor to perform operations comprising: determining potential solutions from node clusters having nodes that represent locations using a genetic algorithm; evolving the potential solutions by performing a simulated annealing process to output evolved solutions, each evolved solution comprising evolved node clusters, and each node being assigned to an evolved node cluster; and invoking a quantum annealer to separately anneal each evolved node cluster of an evolved solution selected from the simulated annealing process to generate an optimal route through the nodes for each evolved node cluster of the selected evolved solution.

Aspect 4: Any of Aspects 1-3, further comprising determining a number of node clusters into which each of the nodes is assigned, the number of node clusters determined from a total number of nodes and a constraint density threshold of the quantum annealer.

Aspect 5: Any of Aspects 1-4, further comprising combining at least a portion of the evolved node clusters for which optimal routes have been generated by the quantum annealer such that the combining of the evolved node clusters reduces a number of evolved node clusters of the selected evolved solution to match a number of vehicles available to traverse the optimal routes.

Aspect 6: Aspect 5, further comprising determining cluster centroids for the evolved node clusters for which optimal routes have been generated, wherein combining the evolved node clusters is based on a distance between the cluster centroids.

Aspect 7: Any of Aspects 1-6, further comprising determining an evolved solution having a minimum total route distance through nodes of the evolved node clusters, wherein the evolved solution selected for the quantum annealer comprises the minimum total route distance.

Aspect 8: Any of Aspects 1-7, wherein: the potential solutions are determined by the genetic algorithm over a first timeframe; the potential solutions are evolved by the simulated annealing process over a second timeframe; the evolved node clusters of the selected evolved solution are annealed by the quantum annealer over a third timeframe; and a number of iterations during which the genetic algorithm and the simulated annealing process are employed is determined from an average of the first timeframe and the second timeframe, the third timeframe, and a total time threshold.

Aspect 9: Any of Aspects 2-8, wherein the node clusters from which the potential solutions are defined using the genetic algorithm comprise prior evolved node clusters determined by the simulated annealing during a prior iteration.

What is claimed is:

1. A computerized method comprising:
clustering nodes that represent locations such that each node is assigned to only one node cluster;
determining potential solutions from the node clusters using a genetic algorithm;
evolving the potential solutions by performing a simulated annealing process to output evolved solutions, each evolved solution comprising evolved node clusters, and each node being assigned to an evolved node cluster; and
invoking a quantum annealer to separately anneal each evolved node cluster of an evolved solution selected from the simulated annealing process to generate an optimal route through the nodes for each evolved node cluster of the selected evolved solution.

2. The method of claim 1, further comprising determining a number of node clusters into which each of the nodes is assigned, the number of node clusters determined from a total number of nodes and a constraint density threshold of the quantum annealer.

3. The method of claim 1, further comprising combining at least a portion of the evolved node clusters for which optimal routes have been generated by the quantum annealer such that the combining of the evolved node clusters reduces a number of evolved node clusters of the selected evolved solution to match a number of vehicles available to traverse the optimal routes.

4. The method of claim 3, further comprising determining cluster centroids for the evolved node clusters for which optimal routes have been generated, wherein combining the evolved node clusters is based on a distance between the cluster centroids.

5. The method of claim 1, further comprising determining an evolved solution having a minimum total route distance through nodes of the evolved node clusters, wherein the evolved solution selected for the quantum annealer comprises the minimum total route distance.

6. The method of claim 1, wherein:
the potential solutions are determined by the genetic algorithm over a first timeframe;
the potential solutions are evolved by the simulated annealing process over a second timeframe;
the evolved node clusters of the selected evolved solution are annealed by the quantum annealer over a third timeframe; and
a number of iterations during which the genetic algorithm and the simulated annealing process are employed is determined from an average of the first timeframe and the second timeframe, the third timeframe, and a total time threshold.

7. A system comprising:
a quantum annealer;
at least one processor; and
one or more computer storage media storing computer-readable instructions thereon that when executed by the at least one processor cause the at least one processor to perform operations comprising:
determining potential solutions from node clusters having nodes that represent locations using a genetic algorithm;
evolving the potential solutions by performing a simulated annealing process to output evolved solutions, each evolved solution comprising evolved node clusters, and each node being assigned to an evolved node cluster; and
invoking the quantum annealer to separately anneal each evolved node cluster of an evolved solution selected from the simulated annealing process to generate an optimal route through the nodes for each evolved node cluster of the selected evolved solution.

8. The system of claim 7, wherein a number of node clusters into which the nodes are assigned is determined from a total number of nodes and a constraint density threshold of the quantum annealer.

9. The system of claim 7, further comprising combining at least a portion of the evolved node clusters for which optimal routes have been generated by the quantum annealer such that the combining of the evolved node clusters reduces a number of evolved node clusters of the selected evolved solution to match a number of vehicles available to traverse the optimal routes.

10. The system of claim 9, further comprising determining cluster centroids for the evolved node clusters for which optimal routes have been generated, wherein combining the evolved node clusters is based on a distance between the cluster centroids.

11. The system of claim 7, further comprising determining an evolved solution having a minimum total route distance through nodes of the evolved node clusters, wherein the evolved solution selected for the quantum annealer comprises the minimum total route distance.

12. The system of claim 7, wherein:
the potential solutions are determined by the genetic algorithm over a first timeframe;
the potential solutions are evolved by the simulated annealing process over a second timeframe;
the evolved node clusters of the selected evolved solution are annealed by the quantum annealer over a third timeframe; and
a number of iterations during which the genetic algorithm and the simulated annealing process are employed is determined from an average of the first timeframe and the second timeframe, the third timeframe, and a total time threshold.

13. The system of claim 7, wherein the node clusters from which the potential solutions are defined using the genetic algorithm comprise prior evolved node clusters determined by the simulated annealing during a prior iteration.

14. One or more computer storage media storing computer-readable instructions thereon that when executed by a processor cause the processor to perform operations comprising:
determining potential solutions from node clusters having nodes that represent locations using a genetic algorithm;
evolving the potential solutions by performing a simulated annealing process to output evolved solutions, each evolved solution comprising evolved node clusters, and each node being assigned to an evolved node cluster; and
invoking a quantum annealer to separately anneal each evolved node cluster of an evolved solution selected from the simulated annealing process to generate an optimal route through the nodes for each evolved node cluster of the selected evolved solution.

15. The media of claim 14, wherein a number of node clusters into which the nodes are assigned is determined from a total number of nodes and a constraint density threshold of the quantum annealer.

16. The media of claim 14, further comprising combining at least a portion of the evolved node clusters for which optimal routes have been generated by the quantum annealer such that the combining of the evolved node clusters reduces a number of evolved node clusters of the selected evolved solution to match a number of vehicles available to traverse the optimal routes.

17. The media of claim 16, further comprising determining cluster centroids for the evolved node clusters for which optimal routes have been generated, wherein combining the evolved node clusters is based on a distance between the cluster centroids.

18. The media of claim 14, further comprising determining an evolved solution having a minimum total route distance through nodes of the evolved node clusters, wherein the evolved solution selected for the quantum annealer comprises the minimum total route distance.

19. The media of claim 14, wherein:
the potential solutions are determined by the genetic algorithm over a first timeframe;
the potential solutions are evolved by the simulated annealing process over a second timeframe;
the evolved node clusters of the selected evolved solution are annealed by the quantum annealer over a third timeframe; and
a number of iterations during which the genetic algorithm and the simulated annealing process are employed is determined from an average of the first timeframe and the second timeframe, the third timeframe, and a total time threshold.

20. The media of claim 14, wherein the node clusters from which the potential solutions are defined using the genetic algorithm comprise prior evolved node clusters determined by the simulated annealing during a prior iteration.
